(19) United States
(12) Patent Application Publication
(10) Pub. No.: US 2009/0058114 A1
(43) Pub. Date: Mar. 5, 2009

(54) Apparatus and method for animal waste collection and containment for use by disabled persons

(76) Inventor: Russel S. Diehl, San Bernardino, CA (US)

Correspondence Address: RUTH EURE, 4795 EDISON AVENUE, BOULDER, CO, 80301, US

(21) Appl. No.: 11/899,052

(22) Filed: Sep. 4, 2007

(51) Int. Cl. A01K 29/00

(52) U.S. Cl. 294/1.4

(57) ABSTRACT

The present invention provides a system for pet waste collection and permanent containment, without the need for someone to lean over or bend down. The invention comprises a combination of two tools. One is a collection tool, having an elongate adjustable length handle having a handgrip at one end and terminating in a waste collection device at the opposite end. The length of the elongated handle is adjusted so as to permit the device to be used by a human without bending over and permits reach under bushes and tables. The pet waste collection device comprises an essentially rectangular receptacle having a front open end to receive the pet waste and back open end for digging out waste deep in the grass. The device also has a removable back stop for preventing the waste from falling out of the receptacle when picking up multiple piles of waste.

### CLAIM OF PRIORITY

None.

### FIELD OF INVENTION

This invention relates to the field of animal waste collection and containment and more specifically to a collection system to aid the disabled or elderly.

### BACKGROUND OF THE INVENTION

Mankind has gained great benefit from the companionship and devotion of canines. This is especially so for the elderly and disabled population. Concomitant with the increase of human population in urban areas, is the rise of canine population in urban areas. The need has arisen for an efficient pet waste disposal device. The eldery and disabled persons enjoy the company of a pet but may sometimes need help with waste disposal.

US Patent to Cyganick, U.S. Pat. No. 2,076,120 shows a garden tool. This tool appears include a form of plate for debris collection and curved teeth for debris breakdown. It is deficient in specific features that make the present invention useful for collecting animal waste, such as a containment system and method of managing varying animal waste viscosity.

US patent to Rundberg, U.S. Pat. No. 1,352,386 shows a rake attachment. This attachment appears to add angled teeth to an existing rake, but appears to be deficient in many animal waste disposal specific requirements such as containment attachments and a method of managing varying levels of waste viscosity.

US patent to Brown, U.S. Pat. No. 4,138,153 shows a sanitary self contained fecal waste container. This container does not include features that make it easy to manage by the disabled or those who cannot bend down easily. It also does not appear to discuss methods or features for remotely closing the container or management of different levels of waste viscosity.

US patent to Nunes, U.S. Pat. No. D409,804 shows an adjustable length pet waste collection tool with a removable handle. It appears that this invention is deficient in many features when compared with the present invention, including a waste containment system and features for managing varying levels of waste viscosity.

U.S. Pat. No. 6,012,748 to Franks includes a device that provides a scoop having an elongate handle and an angled shovel portion. This device requires the user to bend and scoop the animal waste onto a receiving area for collection.

The art also provides U.S. Pat. No. 5,868,447 to Clark which provides an elongate handle portion, but is deficient in many of the other features when compared with the present invention, such as a removable back stop on the dual sided receptacle portion of the present invention which provides versatility over the present invention.

US patent to Miller, U.S. Pat. No. 6,196,600 appears to show an animal waste scooping and disposal device, including a bag system for collecting the waste and a tilt mechanism to keep the waste temporarily contained. It appears that this invention is deficient in numerous features when compared with the present invention, including a system to seal the container remotely and features for the management of varying levels of waste viscosity.

US patent to Kiemer, U.S. Pat. No. 5,628,537 is a pet waste pickup and disposal apparatus which appears to include a bag clip to hold the collection bag in place. The jaw mechanism appears to keep the bag closed, while the operator seals the bag by hand with a tie. It does not appear to provide a mechanism that permanently seals the bag remotely, making it easier for the disabled who have difficulty bending down.

US patent to Rose, U.S. Pat. No. 5,482,337 is a portable excrement scoop including a valve to permit water and air to flow down the handle and out of the scoop but not return. This is to aid cleaning the device. It does not appear to include a waste containment system method or features for the management of varying waste viscosity.

### SUMMARY OF THE INVENTION

The present invention provides improvements over these previous designs by providing a system for pet waste collection and permanent containment, without the need for someone to lean over or bend down. The invention comprises a combination of two tools. One is a collection tool, having an elongate adjustable length handle having a handgrip at one end and terminating in a waste collection device at the opposite end. The length of the elongated handle is adjusted so as to permit the device to be used by a human without bending over and permits reach under bushes and tables. The pet waste collection device comprises an essentially rectangular receptacle having a front open end to receive the pet waste and back open end for digging out waste deep in the grass. The device also has a removable back stop for preventing the waste from falling out of the receptacle when picking up multiple piles of waste.

Alternatively, the back stop can be removed from the device to comprise a rectangular receptacle having an opening at one end to receive the pet waste and an opening at the other end to receive a bag which can be removably attached thereto. The bag receives the pet waste and can then be securely closed and removed from the device for disposal.

The handle can be of adjustable length for ergonomic advantage to accommodate users of various heights. This will also help keep the waste odor further away from the user. The handle permits reach under bushes and tables.

The second tool is a bag seal applicator. This seals the bag closed remotely, so as to permit the applicator to be used by a human without bending over. It includes an elongate fixed length handle having a handgrip at one end and terminating in an applicator at the opposite end. One embodiment shown is a clip applicator, comprising essentially a clip receptacle having an open end to receive the clip and features to grip the clip. Another possible embodiment could apply a staple or shaped wire around the bag to close it.

One point of novelty of the present invention resides in its versatility. With the back stop removed, a disposable bag can be attached. The device can be used to efficiently remove waste from grassy areas and dirt planters with flowers and shrubs by using the forward facing tines as the intake end and attaching a disposable bag to the opposite end. The front end tilted tines allow for a convenient angle to drag or pull the device along the ground in a combing and lifting action without the necessity of bending over by the user. Also, the device can be used to remove waste from very difficult grassy or uneven surfaces by pulling or dragging along the ground using the end with the tines bent upward as the intake end and attaching a disposable bag to the opposite end.

Another point of novelty includes the hose cleaning and waste break up system. The water may travel through the holes in the rectangular collection tray for cleaning to reach the bottom side of the tray. It may also travel through the holes to potentially spray the more soupy waste, which will then break up and be smashed through holes on the lower part of the tray.

Another point of novelty includes features on the hand grip to make it easier to use. The grip may be made from a softer material that is easy to grip, naturally creating some friction and avoiding pressure points. This will make it easier to use for the disabled or elderly. Foam or soft rubber material, for example, may be suitable for use for the handle grip. In addition, the presence of at least one large finger hole may make general manipulation, twisting and rotating of the handle easier at times.

Another point of novelty includes the bag sealing feature. This will help to contain the odor and make management of the bag easier, especially for the disabled.

The present invention provides a complete system in that it provides a device for actual pick-up of the waste in a variety of environments, varying levels of waste viscosity, collection of waste, containment of the waste and sanitization of the device after clean up is accomplished. None of the prior art devices offer a complete system for animal clean-up.

One of the most difficult areas to collect dog waste is in grassy areas. Dog waste can be at any depth in the grass and of any consistency, from hard to soupy. The device of the present invention addresses all of these problems effectively and maintains a clean and healthy environment. The device can be easily used with one hand, leaving the other hand free to carry a water hose, bag, bag holder, or any other container of choice.

In summary, the elongated handle is adjustable in length for easy handling. The long, bent pick-up tines can be adjusted to any depth in the grass by raising or lowering the elongated handle. The dog waste pick-up tray or receptacle of the device can be used with a plastic back-stop, which can be attached in two places in the tray; one for exposing the short tines, if desired, the other to increase the capacity of the pick-up tray. When the back stop is used in the pick-up tray, it has a limited waste capacity, usually three or four piles, depending on size. In this configuration, using a shopping bag holder or container of choice is preferred. When the device is used with an 8×12 inch plastic bag, the backstop is removed from the pick-up tray and the bag is attached and secured to the opposite end of the long bent tines with a rubber band. When the bag is full, a clip applicator or some similar means may be used to seal the bag closed.

When using the bent tines to pick up dog waste in grass areas, the elongated handle is held at approximately a 70° angle, the angled tip ends of the tines are placed on the ground near the dog waste and the device is pulled toward the waste laying on top of the grass blades. The long tines are pulled under the waste in a combing and lifting action to lift the waste onto the flat center section of the tray. This action is continued until all waste is collected or the tray is full. Rotating the device will cause waste to fall against the backstop section of the tray or into the plastic bag if used.

If waste is deeper in the grass and not on the surface, the handle is raised or lowered to adjust the depth for proper pick up. When a soupy dog waste is addressed, a water hose is used to wash waste into soil. Larger pieces are broken up by the bottom section with holes for mashing and short tines are used to comb and clean the grass. Any remaining pieces of waste can be picked up with short tines.

The objective is to provide an inexpensive, light weight, easy to use, and clean pet waste pick up device for use in backyard grass lawns, and to solve many of the problems presented in picking up dog waste in grass lawns, and to satisfy the need of a very diverse usership to maintain a healthy environment to be easily used by a small child and the elderly. Many of the elderly have poor vision, depth perception, hand grip, some paralysis and bending over is difficult. The device of the present invention can be used effectively with 2 fingers: the thumb and one other finger.

The device of the present invention is able to pick up large and very small pea sized waste of any consistency from hard to soupy and to pick up small pieces deep ion the grass and smash and break up soft and soupy waste when using a garden hose to expedite microbe break down.

Each function of the device: The handle is adjustable in length with a soft grip with large finger holes adjustable to any height user and to extend to reach over a fence or obstacle with special thread that remains tight in use. Handle threads into top of device which has a drain hole to prevent accumulation, water, and dirt when cleaning the device with a hose.

Also, it can be extended to reduce odor during pick up and can be rotated 360 degrees for pick up in any terrain such as hills and valleys, and in any type of grass such as fescue, Bermuda or crab grass. The main body consists of a top center section with threaded attachment to a cap with a drain hole for mounting of adjustable handle and attaching back stop slots for holding a rubber band when a bag is used for pick up. The bag can be 8×12 inches in size.

The side section is angled from the top to the bottom so the front and back tines are visible during waste pick up and hold the waste in the bottom of the tray when the device is rotated. The bottom pick up tray section back portion has six small short straight tines and two wide blunt tines for corner strength and mounting holes for the back stop. These six small short straight tines and two wide blunt tines are used to break up waste and dig out flattened and small pieces of waste deep in the grass and used in dirt areas of garden for waste pick up. All of these features are usable with the back stop in place.

The bottom tray center portion with spaced holes is used in mashing and breaking up waste when a hose is used and for draining water from morning dew, rain, and sprinklers. The holes help to reduce the weight and create friction so waste stays in the bottom of the tray. The holes also provide means for mounting the backstop. The from section of the device has wide, flat, and long tapered tines bent to a specific angle of 30 degrees ⅔ from the tip of the tines permitting only this portion of the pick up tray to make ground or grass contact. This section must support its own weight in order to work properly and not sink into the grass. The weight of the device is less than 12 ounces, which is critical to proper use.

The skiing or skimming ability of the device allows the use to pick up many pieces of waste separated by a foot or more without lifting the device from the ground. In the dog waste pick up process the long bent portion of the tines are pulled under the dog waste and the waste is pushed onto the tray by the grass blades that are gathered together by the pulling of the device and the shape of the angled tines.

The open front tip of the tines are three times the width of the back portion of the tines and gather grass blades together to form a brush, pushing the dog waste onto the bottom of the tray with holes and the grass blades are bent and exit through the 30 degree elevated back section of the tines with minimum friction. The pieces not pushed onto the tray by the grass blades are cradled and held in the knee of the bent tines. The device is rotated 180 degrees on the bottom flat square portion with the holes creating a 60 degree angle so that the dog waste will fall into the holding portion of the tray and is held in by the backstop. If waste does not fall into the tray, then the device is tapped on the ground. The tapping on the ground loosens the waste so that it is free to fall into the tray. This grass brush pushing action is absolutely essential for the device to pick up multiple pieces or piles of dog waste. There is a small ridge running from side to side across the bottom of the holding tray to keep the waste in the tray when another pick up is made.

The removable backstop is needed to keep the dog waste from falling out the back section of the tray when being rotated during pick up. The backstop is made of strong, flexible material and is easy to remove for cleaning and when attaching a plastic pick up bag.

When a plastic pickup bag is attached and secured with a rubber band, and is engaged in four slots, after each pick up the bag closes, reduced 90 percent of the odor when carrying the device to the next pick up. When all pick ups are complete the bag can be laid on the ground and the device is rotate several times, thereby twisting the bag closed. The bag can be permanently closed by inserting a plastic bag closer clip, with the aid of the closer clip wand or it can be lifted from the ground and will automatically untwist itself and be ready for the next pick up.

The plastic bag contemplated is a typical 8×12 inch dog waste bag found in many recreational areas, apartments, parks and pet stores. In order for the device to function as described above, the dimensions of the device must be slightly smaller than the 8×12 bag, which has an effective opening of about 16 inches. This is so the bag can be easily inserted with the hand inside the device and the bag opening can be folded over the device and the rubber band can be placed around the bag and inserted into the four slots. At this point, the bag is pulled back and the device is ready to be used.

### BRIEF DESCRIPTION OF THE DRAWINGS

FIG. 1 shows an embodiment of the waste collection apparatus.

FIG. 2 shows a view of the under side of the collection plate.

FIG. 3 shows a top view of the collector plate and support member.

FIG. 4 shows a side view of the collector plate and support member.

FIG. 5 shows an embodiment of the back stop.

FIG. 6 shows an embodiment of the waste collection apparatus with the bag attached.

FIG. 7 shows an embodiment of the bag clip application apparatus.

FIG. 8 shows a side view of a bag clip application apparatus.

FIG. 9 shows an embodiment of a bag clip.

FIG. 10 shows an embodiment of the collector apparatus with the bag clipped.

FIG. 11 shows a side view of the collector plate and support member and the attachment of the handle.

FIG. 12 shows the elongate adjustable handle and the attachment to the collector plate and support member.

FIG. 13 shows the sequence of attaching and using the attachable bag.

### DETAILED DESCRIPTION

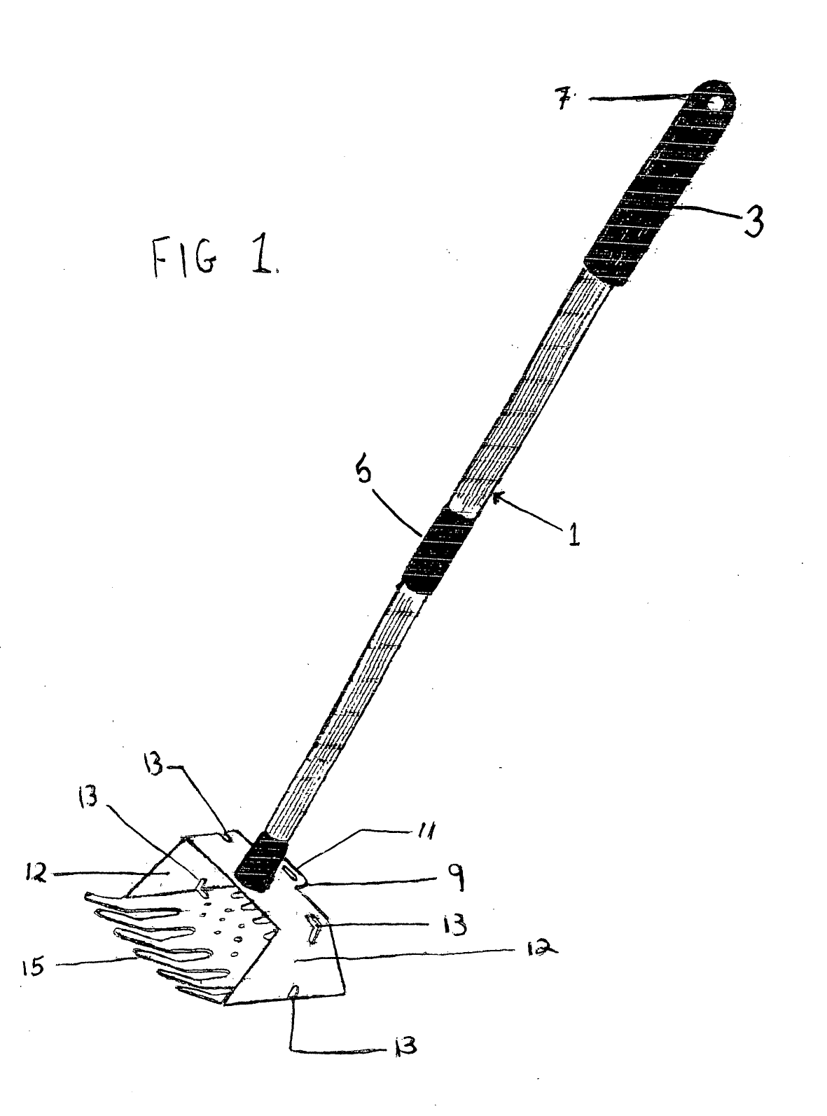

FIG. 1 shows the collector apparatus including an elongate collector handle 1, which terminates at one end in a collector handle grip 3. There is a collector handle adjustable length collar 5 approximately midway along the length of the collector handle 1. The length of the collector handle 1 is adjusted by rotating the adjustable length collar 5 to loosen the telescoping handle 1, extending or shortening the handle 1 to its desired length and then rotating the adjustable length collar 5 in the opposite direction to tighten it. The handle 1 can then be extended to reach over a fence or obstacle or keep the odor as far away from the user as possible. It can also be shortened for someone in a wheelchair who is closer to the ground. The handle grip 3 is made of a soft material so as to be comfortable to use, for example rubber or foam. The handle grip 3 also has at least one finger hole 7 to make it easier to hold and manipulate if needed.

The opposite end of the collector handle 1 is attached to the center of the collector handle support member 9. This support member 9 may be attached using threads, press fits or other mechanical means. The support member 9 may contain a back stop slot 11 and a rubber band slot 13. The support member sides may also be angled to reduce the apparatus weight and maximize visibility during use. The support member 9 is connected to collection plate 15 which consists of a plate with a variety of tines and holes in it. The collection plate 15 may have a back stop slot hand a rubber band slot 13 that correlates in position with any matching slots in the support member 9.

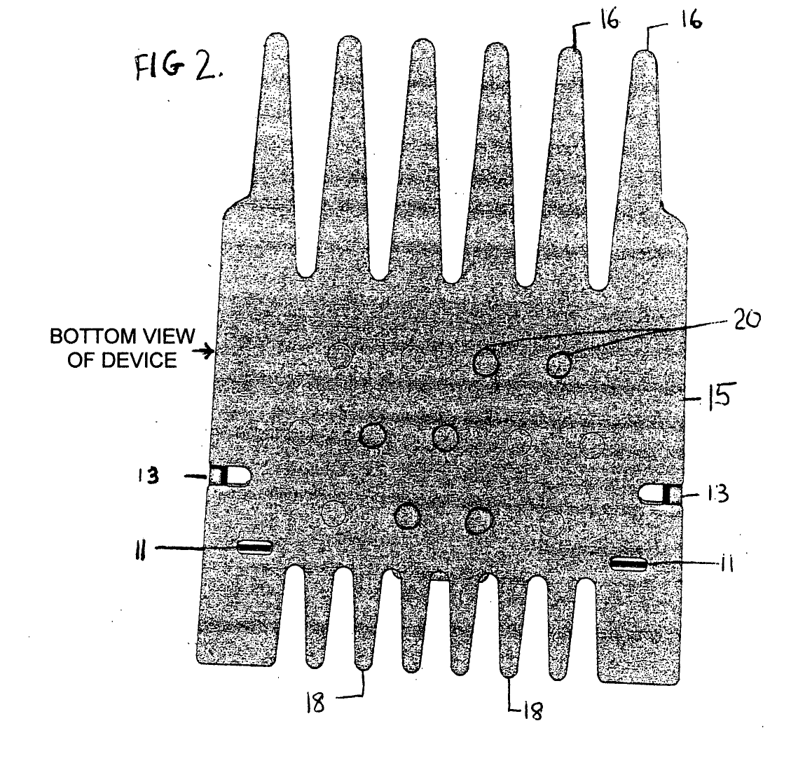

FIG. 2 shows the under side of the collector plate 15. It consists of a leading section with longer collection tines 16 and a rear section with shorter digging tines 18. There are at least two longer collection tines 16 and at least two shorter digging tines 18. The longer tines may be approximately three tines as long as the digging tines 18. The digging tines 18 are used to brake up waste and dig out flattened and small pieces of waste that is deep in the grass. They can also be used in dirt areas for waste collection. In the middle portion of the plate 15 there is at least one hole 20 through the plate 15. These hole(s) 20 reduce the weight of the apparatus and may create friction to keep the waste in place once collected.

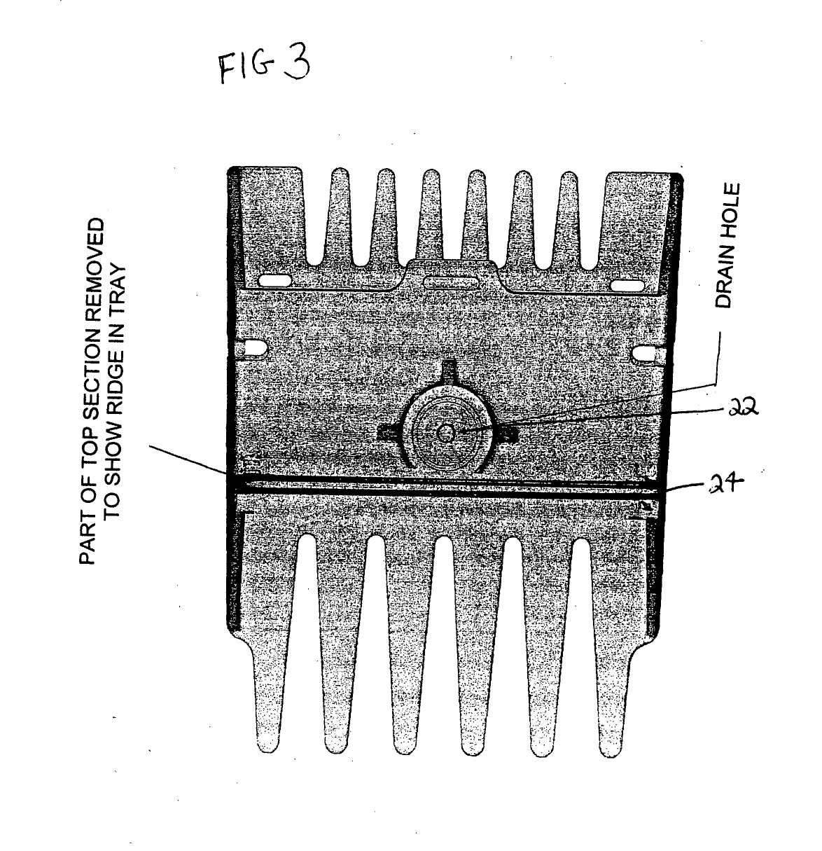

FIG. 3 shows a top view of the plate 15 and support member 9. At the handle 1 attachment point there at least one drain hole 22. This drain hole 22 is to allow water from a hose to travel through the support member 9 down to the plate 15. The combination of the hole(s) and water from the hose is intended to break up the less solid waste. It will also ease cleaning of the apparatus. The hose may be attached directly to the support member 9 or to the handle 1 or through a separate connection along the handle 1. FIG. 3 also shows a ridge 24 that may be used to keep the waste form escaping.

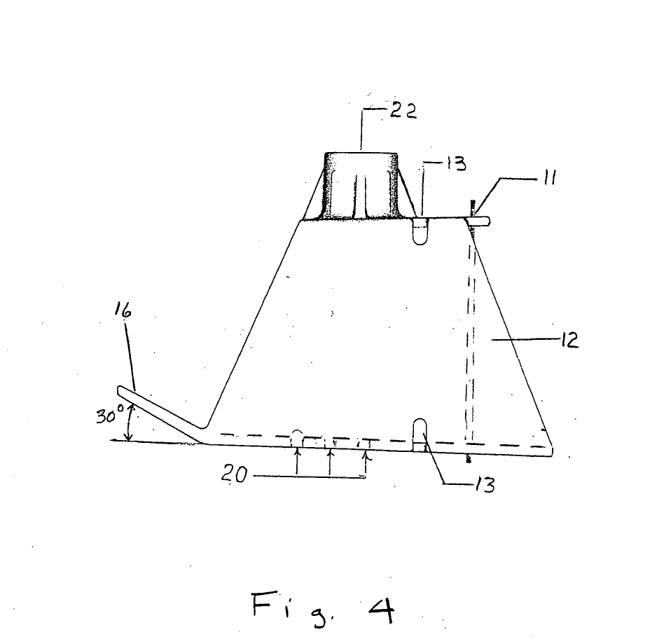

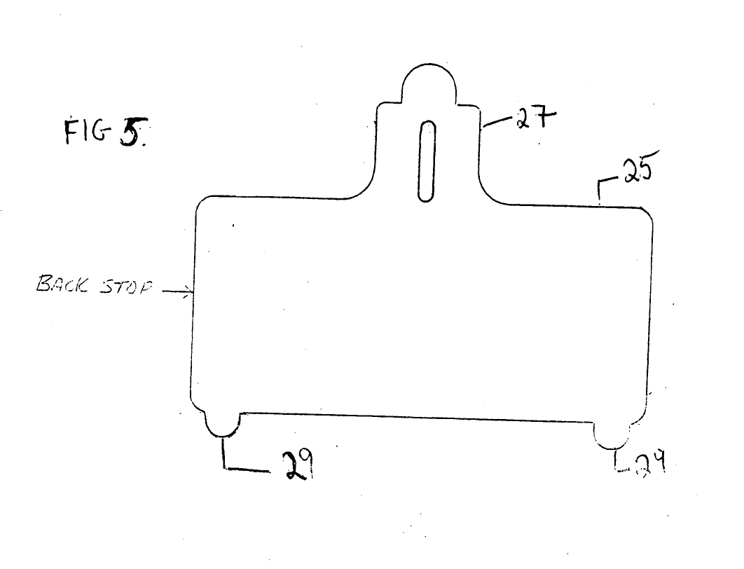

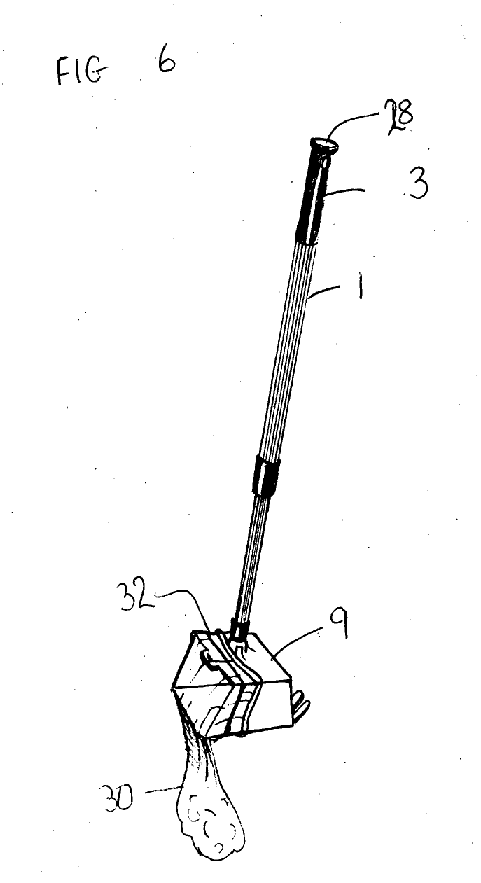

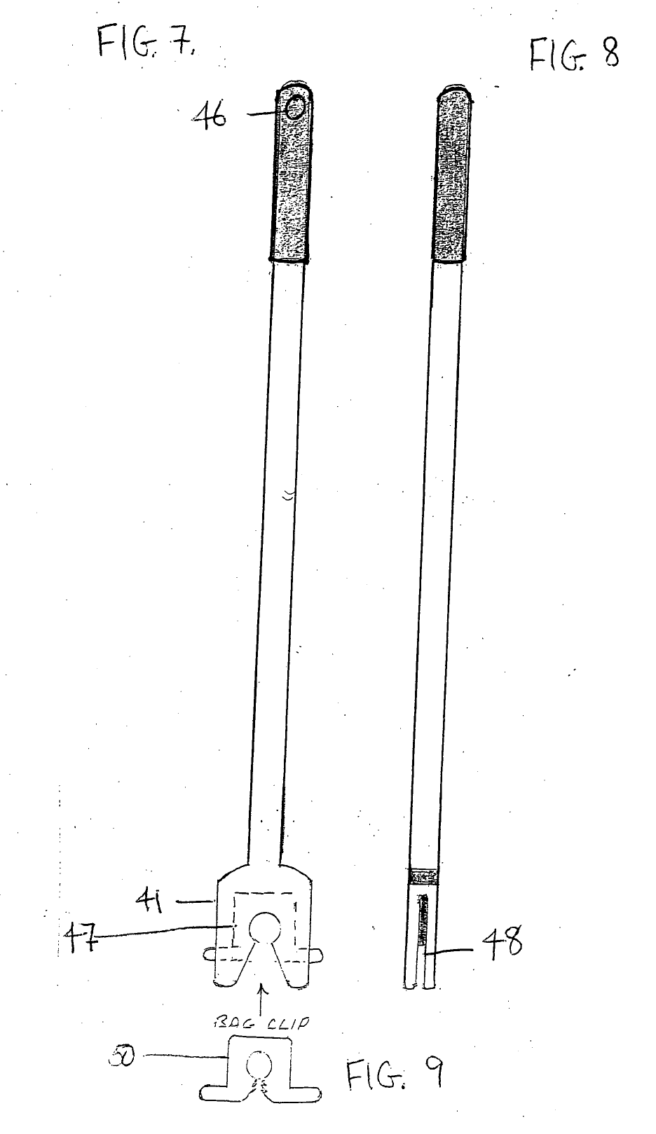

FIG. 4 shows a cross section of the collector plate 15 and support member 9. It also shows the longer collector tines 16. These tines are angled at about thirty degrees for some portion of the length of the tines, for example about two thirds of their length. During waste collection the longer tines 16 gather grass blades together to form a brush, pushing waste onto the plate 15 and the grass blades bend away as you continue to move the plate 15 along the grass.

FIG. 5 shows the back stop 25. The back stop consists of a plate with a handle portion and at least one protrusion(s) 29. The protrusion(s) 29 may mate with the back stop slots 11 in the plate 15. The back stop is removable and keeps the waste from falling out of the collector when used. The backstop 25 is made from a lightweight flexible material, for example some plastics.

FIG. 6 shows the collecting apparatus with the handle hose connection 28 in the handle. A hose may be attached at this connection 28 to clean the handle 1, collection plate 15 and support member 9. FIG. 6 also shows the attachment of a collection bag 30 using a rubber band 32. The rubber band 32 should be sufficiently tight enough to keep the bag 30 on securely during collection. The bag should be slightly larger than the cross sectional size of the support member 9 and plate 15, so as to easy to assemble. Standard waste bags have a sixteen inch opening. Therefore the circumference of the collection apparatus including the support member length, support member sides 12 lengths and plate 15 widths should be less than sixteen inches.

FIG. 7 shows the bag clipping handle 40 and applicator 41. The bag clipping handle terminates at one end in a bag clipping handle grip 43. There is a bag clipping handle adjustable length collar 45 approximately midway along the length of the bag clipping handle 40. The length of the handle 40 is adjusted by rotating the adjustable length collar 45 to loosen the telescoping handle 40, extending or shortening the handle 40 to its desired length and then rotating the adjustable length collar 45 in the opposite direction to tighten it. The handle 40 can then be extended to reach the collecting apparatus. The handle grip 43 is made of a soft material so as to be comfortable to use, for example rubber or foam. The handle grip 43 also has at least one finger hole 46 to make it easier to hold and manipulate if needed. The opposite end of the bag clipping handle 40 has a bag clip applicator 41, which consists of a clip receptacle 47.

FIG. 8 shows a side view of the bag clipping handle, including the clip receptacle slot 48.

FIG. 9 shows the clip 50 that is inserted into the clip receptacle in the bag clip applicator. The clip 50 is similar to those often used to close bread bags. Using the handle 40, this clip can be snapped over the bag 30 once filled with waste.

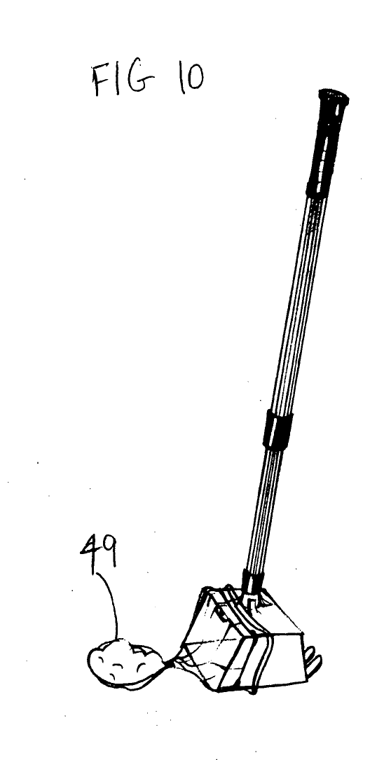

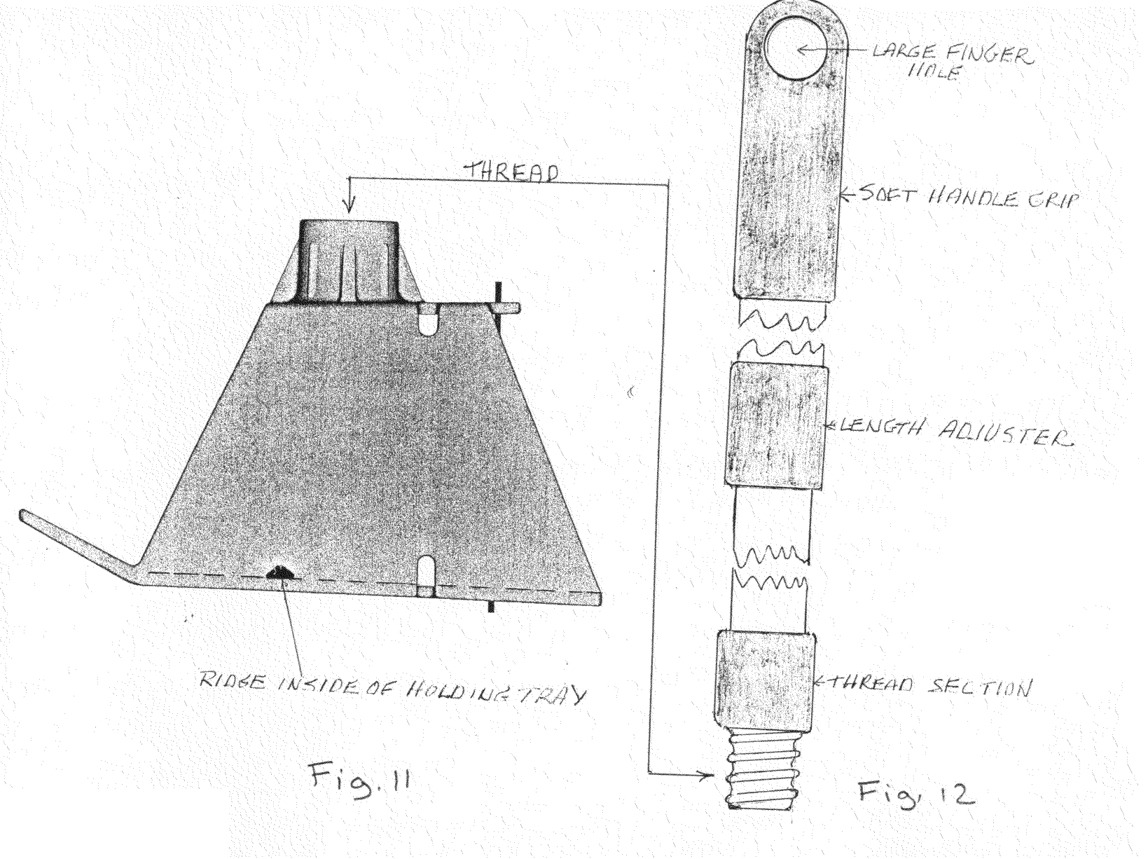

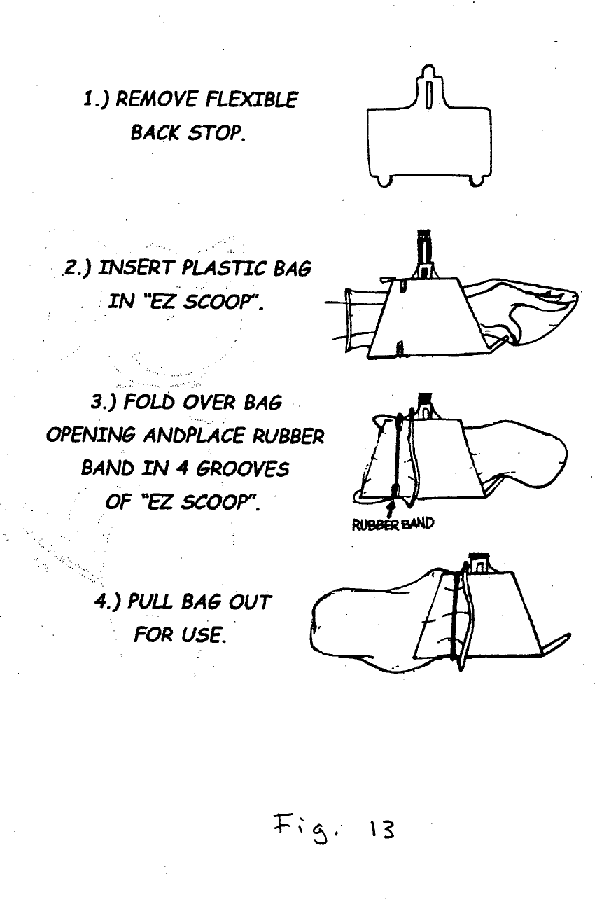

FIG. 10 shows the bag with the clip applied.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

What is claimed is:

1. A system for collecting and containing animal waste for the disabled comprising;
a waste collecting tool and a container sealing tool said collecting tool has an elongate handle and a receptacle for receiving waste, means for attaching the receptacle to the handle, said receptacle having a bottom portion, leading section and rear section, said leading section having a plurality of spaced apart uniformly bent tines and said rear section which can receive a container,
said bag sealing tool has an elongate handle and an applicator with means to seal the container.

2. The waste collecting tool and container sealing tool of claim 1 wherein at least one of the handles are extendable

3. The waste collecting tool and container sealing tool of claim 1 wherein at least one of the handles has a grip made out of a soft material including foam and rubber.

4. The waste collecting tool and container sealing tool of claim 1 wherein at least one of the handles has at least one finger hole.

5. The waste collecting tool of claim 1 wherein the handle has a connection for a hose for cleaning the tool.

6. The waste collecting tool of claim 1 wherein the receptacle has a drain hole where the handle is attached to allow water to drain down onto the bottom side of the receptacle.

7. The waste collecting tool of claim 1 wherein there is at least one hole in the bottom section of the receptacle to allow water and soupy waste to drain.

8. The waste collecting tool of claim 1 further comprising a removable back stop.

9. The waste collecting tool of claim 1 further comprising slots in the receptacle for holding a container onto the receptacle with a rubber band.

10. The waste collecting tool of claim 1 further comprising at least one short straight tine in the rear section for digging and using said tine to collect and manipulate waste.

11. The waste collecting tool of claim 1 where the tines on the leading section are uniformly bent at approximately 30 degrees.

12. The container sealing tool of claim 1 further comprising mechanical closure means to seal the container.
